(19) United States
(12) Patent Application Publication
(10) Pub. No.: US 2009/0012857 A1
(43) Pub. Date: Jan. 8, 2009

(54) Real estate sign system

(76) Inventor: Gerald L. Schelfaut, Bloomington, IL (US)

Correspondence Address: DUNLAP CODDING, P.C., PO BOX 16370, OKLAHOMA CITY, OK, 73113, US

(21) Appl. No.: 11/825,487

(22) Filed: Jul. 6, 2007

(51) Int. Cl. G06Q 50/00; G06Q 30/00; G09F 19/00

(52) U.S. Cl. 705/14

(57) ABSTRACT

A real estate sign system comprising a plurality of real estate signs, a control system, a communications system, and a plurality of user devices. The real estate signs comprising an electronic device which communicates with the communications system and displays messages to viewers using a visual display, and a stand which supports the electronic device. The user devices accepts information from a user and communicates that information to the real estate sign system. The control system comprising a web server, which communicates with the user device, and a communications component which communicates with the communications system. The web server also communicates with the database to generate a message to be transferred to the real estate sign. The web server further communicates with the communications component to transfer information to the real estate sign.

### FIELD OF THE INVENTION

The present invention relates to a real estate sign system designed to enhance the overall effectiveness of information delivery and additionally to save the listing real estate agent time and money. In one embodiment, the current invention enables a real estate listing agent to change the information being displayed on the real estate sign relative to a piece of real estate property from the real estate agents remotely located office, home, or other location by using a user device and a communications system utilizing wireless communications technology.

### BACKGROUND OF THE INVENTION

The conventional method of marketing a piece of real estate property relies on a real estate sign displaying information in a static manner to potential buyers. Typically, the conventional sign would reflect things such as the real estate company, the listing agents and their contact information, and the typical “For Sale” placard. This method suffers from several limitations.

When a change in the status of a piece of real estate property occurs, such as “offer pending” or “reduced price”, initially this information is typically known only to the listing agent. This updated information is not typically available to potential buyers until the real estate agent travels to the piece of real estate property and physically changes the information on the real estate sign. This subsequent delay between the time when the change in status occurs and the time when the conventional real estate sign can be updated to reflect the updated status can be considerable. This delay results in misinformation being presented to potential buyers which potentially results in missed opportunities to sell the property. The ability to change the message being displayed on the real estate sign quickly after a change in status occurs would save the listing agent both time and money.

Another limitation of a conventional real estate sign is the effort required by the listing agent to make the changes to a conventional real estate sign. Again, when a change in status occurs, the listing real estate agent must physically travel to the location of the piece of property and make the changes to the real estate sign. It is common for real estate agents to have properties listed considerable distances from each other or the listing agents office. The time and effort spent traveling to these properties and making these changes to the conventional real estate sign result in unnecessary costs to the listing agent in both time and money.

An additional limitation of a conventional real estate sign is that they are limited in the manner in which they can present information relating to a piece of property to potential buyers. Typically, a conventional real estate sign displays information in a static manner, usually on a placard on the display panel. This limits the amount of attention it attracts of would-be purchasers. This limitation results in less attention being drawn to the piece of property being offered for sale and more missed sales.

There are clear limitations to a conventional real estate sign and it is these limitations that the present invention is meant to address.

### BRIEF DESCRIPTION OF THE DRAWINGS

FIG. 1 is an overview of a real estate sign system constructed in accordance with the present invention.

FIG. 2 is a representation of a real estate sign constructed in accordance with the present invention.

FIG. 3 is a block diagram of an electronic device of the real estate sign constructed in accordance with the real estate system.

FIG. 4 is a block diagram of a control system of the real estate sign system constructed in accordance with the present invention.

FIG. 5 is a block diagram of a user device of the real estate sign system constructed in accordance with the present invention.

### DETAILED DESCRIPTION OF THE INVENTION

### System Overview

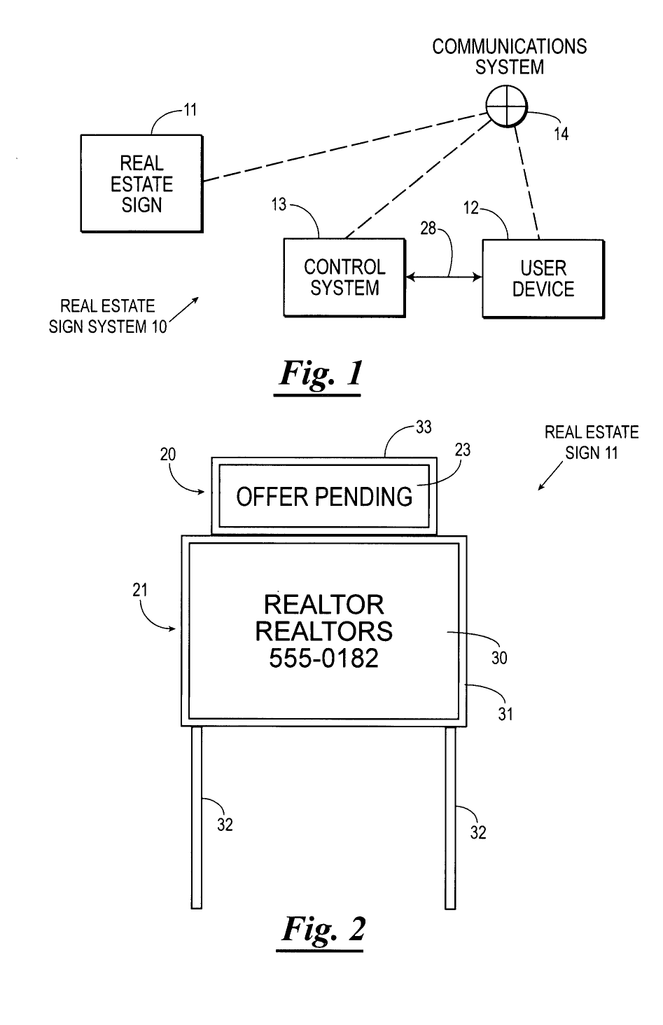

Referring now to the drawings, and in particular to FIG. 1, shown therein and designated by a reference numeral 10 is an illustration of a real estate sign system constructed in accordance with the present invention. In one embodiment, the real estate sign system 10 comprises a plurality of real estate signs 11, a plurality of user devices 12, a control system 13, and wireless communications system 14.

In another embodiment, as will be explained further below, where the functions of the control system 13 are incorporated into the user device 12, the real estate sign system 10 comprises the plurality of user devices 12, the wireless communications system 14, and a plurality of real estate signs 11.

The user device 12 permits the user, located remotely from the real estate sign 11, to enter, and then communicate information relating to a desired message to be displayed, and the manner in which the message is displayed, on the real estate sign 11, without having to physically travel to the relative location of the real estate sign 11.

The control system 13 accepts information from the user device 12 and then communicates that information to the real estate sign 11 via the communications system 14. The control system 13 communicates with the user device 12 in order to authenticate the user and then provides the method for the user to enter the information relating to the desired message to be displayed, and the manner in which the message is displayed, on the real estate sign 11. Once the control system 13 receives the information from the user device 12, that information is communicated to the real estate sign 11 via the communications system 14.

The real estate sign 11 preferable includes a stand 21 configured as a conventional real estate sign used by a real estate agent to mount the electronic device 20, which will be further explained below when referring to FIG. 2. The real estate sign 11 is located relative to the piece of real estate being offered. The real estate sign 11, utilizing the electronic device 20, explained below when referring to FIG. 2, enables the user to visually display messages to viewers regarding the current status of a piece of real estate property. Some examples of messages that could be displayed on the real estate sign 11 are “For Sale”, “Offer Pending”, “Reduced Price” and so on. As will be understood by one skilled in the art, the real estate sign 11 could display one of the messages previously mentioned or any number of either preconceived messages or a user composed message.

As will be understood by those having ordinary skill in the art, the communications system 14 is preferable an existing communication network utilizing either cellular or satellite based wireless technology. However, it should be understood that the communications system 14 can include technology that is developed hereafter.

### Real Estate Sign

Now turning to the real estate sign 11 as designated in FIG. 2. The plurality of real estate signs 11 comprise the electronic device 20 and the stand 21. The real estate sign 11 communicates with the control system 13, via the communications system 14, to exchange data, and then processes that data in order to generate a message to be displayed on the visual display 23.

The electronic device 20 further comprises a visual display 23 which provides the means to display messages to viewers in a method designed to attract attention to the real estate sign 11. The visual display 23 can be configured to display the message to viewers in a variety of methods including, but not limited to a static position, scrolling from left-to-right or right-to-left, flashing, or other methods, as understood by those having ordinary skill in the arts. The preferred method of displaying the message would be determined by the user who deems a particular method to further draw attention to the real estate sign 11.

The electronic device 20 includes a housing 33 which is adapted to be supported by the stand 21. The housing 33 is further adapted to withstand environmental conditions.

The stand 21 comprises a display panel 30, a frame 31, and a plurality of legs 32. The display panel 30 would typically, but does not have to, display such things as the listing agents name and phone number as well as the listing real estate company. The display panel 30 would be, but does not have to be of a size to be substantially contained within or mounted onto the frame 31. In addition, the display panel 31 could be broken down into a plurality of smaller display panels.

The frame 31 would serve to support the display panel 30. The legs 32 would support the frame 31, display panel 30 and electronic device 20 and would also provide a means to mount the real estate sign 11. Although FIG. 2 shows two legs 32, it would be understood by one having ordinary skill in the art that any number of legs 32 may be used to support the real estate sign 11.

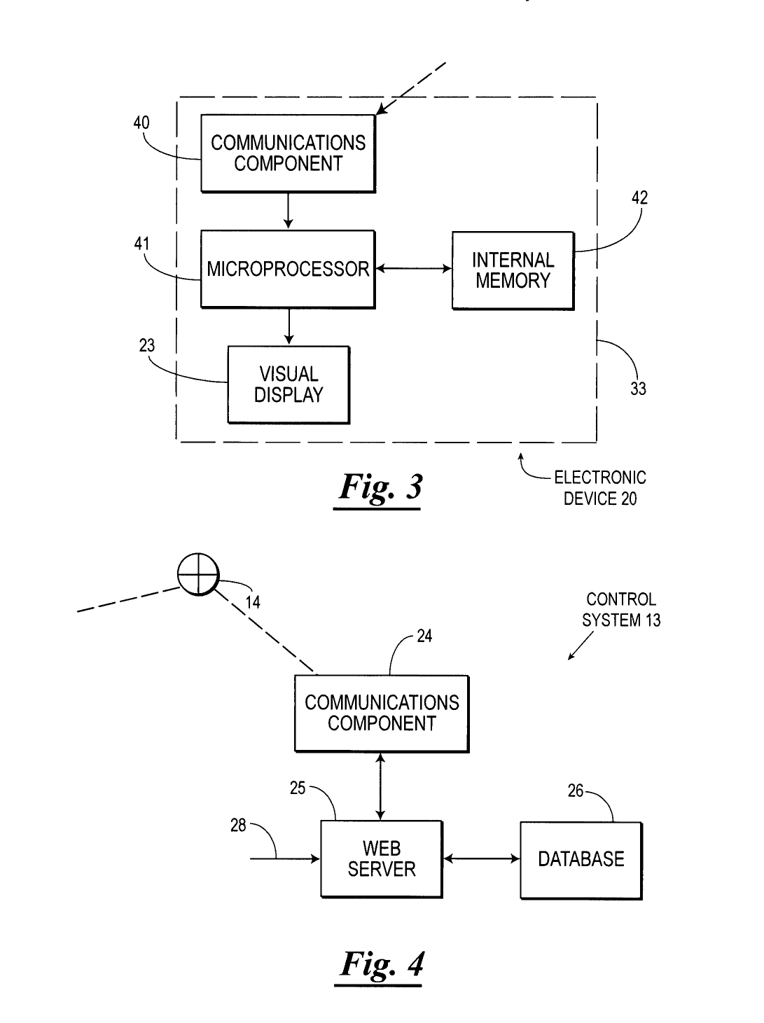

Turning to FIG. 3 therein described in greater detail is the electronic device 20. The electronic device 20 comprises a communications component 40, a microprocessor 41, internal memory 42, a visual display 23, and a housing 33. The communications component 40 provides the communications link between the electronic device 20 of the real estate sign 11 and the control system 13 via the communications system 14. As will be understood by one having ordinary skill in the art, the communications component 40 communicates with the communications system 14 preferably using satellite or cellular wireless communication technologies as described above. The communications component 40 further communicates with the microprocessor 41 relaying information from the control system 13 via the communications system 14.

The microprocessor 41 communicates with the communications component 40 to transfer information from the control system 13 via the communication system 14. The microprocessor 41 then communicates with the internal memory 42 in order to generate the desired message to be displayed on the visual display 23 and what method to display the message. The microprocessor 41 then communicates with the visual display 23 in order to display the desired message to the viewers in the preferred method.

The internal memory 42 stores preconceived messages to be displayed as well as additional information necessary for the operation of the electronic device 20. Additionally, the internal memory 42 would store information relative to the desired method to display the message to the viewers.

### Control System

The control system 13, shown in FIG. 4, comprises a communications component 24, a web server 25, and a database 26. The communications component 24 serves the same purpose as the communications component 40 of the electronic device 20 described above. The communications component 24 serves as the communications link between the communications system 14 and the control system 13. The communications component 24 communicates with the communications system 14 preferably using satellite or cellular wireless communication technologies as described above.

The web server 25 communicates with the user devices 12 via path 28 which could be internet, network, modem, or any other means understood by one having ordinary skill in the art, to authenticate users and also to receive information from the user relating to the desired message to be displayed, and the manner in which to display the message, on the real estate signs 11. The web server 25 then communicates with the database 26 to generate the information to be transferred to the real estate sign 11 using communications component 24 via the communications system 14. The web server 25 communicates with the communications component 24 in order to transfer information to the real estate sign 11 via the communications system 14. In another embodiment, the control system 13 can have a logon server that is separate from the web server 25.

The database 26 communicates with the web server 25 to authenticate the user of the user device 12 and further store information relating to particular users such as assigned real estate signs, their location and current message being displayed to viewers, and manner in which the message is being displayed. As would be understood by one having ordinary skill in the art, the database 26 would store additional information necessary for routine operations of the control system 13 or the real estate sign system 10.

### User Device

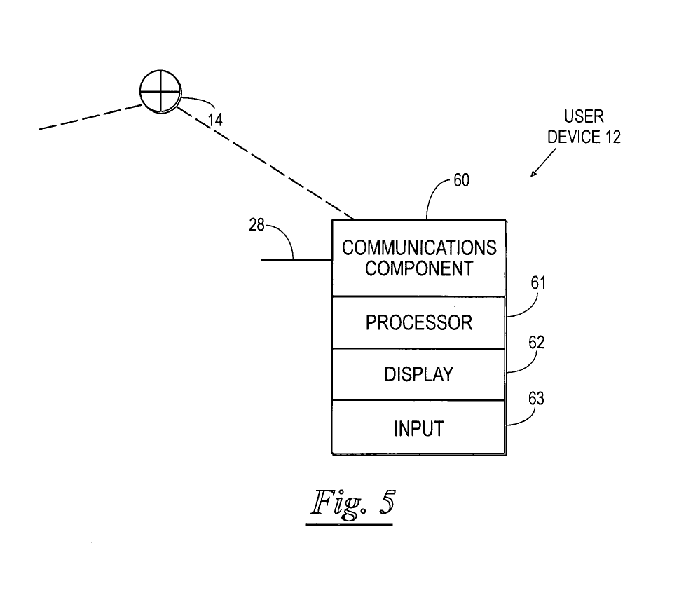

Turning to the user device 12 as represented in FIG. 5. The user device 12 provides the interface for the user to access the real estate sign system 10. The user device 12 comprises a communications component 60, a processor 61, a display 62, and an input 63.

The communications component 60 provides a means for the user device 12 to communicate with the control system 13 via path 28 using internet, network, modem, or other means as understood by one having ordinary skills in the art. The communications component 60 further communicates with the processor 61 to transfer information received by the user using input 63. The input 63 and display 62 provide a means for the user to interface with the user device 12. The display 62 can be a CRT, monitor, cell phone screen, microphone, touch screen, or other mechanism as understood by one having ordinary skills in the art. The input can be a keyboard, keypad, cellphone keypad, or other device as understood by one having ordinary skills in the art.

The processor 61 serves as a link between the display 62/input 63 and the communications component 60. The processor 61 derives the information to be transferred to the control system 13 based on information gathered from the user using the display 62/input 63 components.

The user device 12 can be a computer, cell phone, PDA, or other device which permits the user to enter information and then communicate that information to the real estate sign 11 via the control system 13 using the communications system 14. The user device 12 contains a means for the user to access their information relating to the real estate sign system 10 and make changes to that information as desired. Preferably the user device 12 is programmed with a browser program to permit the user device 12 to communicate with the web server 25 of the control system 13.

### Communications System

Now turning to the communications system 14. The communications system 14 can be a conventional cellular or satellite wireless communication system. In this embodiment, the communications system 14 operates in the appropriate frequency bands associated with the cellular or satellite communications system. The choice between which system to use, satellite or cellular, would be determined by many factors such as cost, availability/congestion and other considerations understood by one having ordinary skills in the art. Such systems are well known in the art, therefore no further explanation is necessary to enable one skilled in the art to implement the present invention.

### ALTERNATE EMBODIMENT

In an alternate embodiment of the real estate sign system 10, the essential functions of the control system 13 can be incorporated into the plurality of user devices 12, thus eliminating the control system 13. In that instance, the communications component 60 of the user device 12 would communicate directly with the real estate sign 11 via the communications system 14, preferably using satellite or cellular wireless communications.

Also, in this alternate embodiment, the authentication functionality between the control system 13 and the user device 12 would be incorporated into the user device 12 and the real estate sign 11. One possible method for authentication might be the use of electronic serial numbers associated with a particular user device 12. Although other methods of authentication may be employed.

One example of an alternate embodiment is the user device 12 consisting of a conventional cell phone, operated either using satellite or cellular communication technologies. The user would enter an identification number of a particular real estate sign 11 or piece of real estate property, the desired message to be displayed on the real estate sign 11, and the method to display the message as a text message that would then be transmitted to the real estate sign 11. In this example, the communication component 40 of the electronic device 20 of the real estate sign 11 would receive the text message from the user device 12, via the communications system 14, and authenticate the user based on the phone number transmitted in the caller ID or the electronic serial number of the cell phone operating as the user device 12. Upon verification of the user via user device 12, the electronic device 20 would generate the desired message, in the desired display manner. As would be understood by one having ordinary skill in the art, there are other alternate forms for this embodiment that may be realized without departing from the claims.

### Real Estate Sign System Process

Now turning to the process of a user changing the message being displayed on the real estate sign 11. The user accesses a user device 12 to transmit a request for access to the control system 13. The control system 13 receives the request for access from the user device 12 and transmits a screen presenting a means to authenticate the user of the device. The user device 12 receives a screen from the control system 13 and displays the screen presenting the means to authenticate the user of the user device 12. The user of the user device 12 enters personal and/or security information and transmits that information to the control system 13. The control system 13 receives the personal and/or security information from the user device 12 and communicates with a database 26 to authenticate the user.

After authenticating the user, the control system 13 transmits to the user device 12 a screen to present that particular user's information and data relating to the real estate sign system 10. The user device 12 receives and displays the screen presenting that user's information and data relating to the real estate sign system 10 from the control system 13.

The user selects one of a plurality of options for updating the real estate sign system 10 such as updating an existing real estate sign 11 or adding a new real estate sign 11.

When updating an existing real estate sign 11, the user enters the updated information such as a new message to be displayed on the visual display 23 of the electronic device 20 of the real estate sign 11 or updates the information relating to the physical location of the real estate sign 11. When adding a new real estate sign 11, the user enters the information relating to the new real estate sign 11 such as a unique identification number, information relating to the physical location of the new real estate sign 11, a message to be displayed on the visual display 23 of the electronic device 20 of the new real estate sign 11, and the manner in which to display the message.

Once the user has entered the updated information, the user device 12 transmits that information to the control system 13. The control system 13 receives the updated information from the user device 12 and communicates with the database 26 to store the new information applicable to the user and further communicates with the communications component 24 to transmit the message to be displayed on the real estate sign.

The control system 13 transmits to the user device 12 a screen presenting a confirmation of the updated information being processed and awaits further inputs from the user such as when the user wishes to update additional real estate signs 11 or add new real estate signs 11. The user can then select a second real estate sign 11 to submit updated information to, or selects an option to add additional real estate signs 11, or selects the option to terminate the session with the control system 13.

When submitting updated information to a second real estate sign 11 or adding additional real estate signs 11, the user repeats the steps described above. When terminating the session with the control system 13, the user selects the option to terminate the current session and this information is transmitted to the control system 13. The control system 13 receives the request to terminate the current session and communicates with the database 26 to terminate the current session. The control system 13 transmits a screen to the user device 12 presenting a confirmation that the current session has been terminated.

Changes may also be made in the construction and the operation of the various components, elements and assemblies described herein or in the steps or the sequence of steps of the methods described herein without departing from the spirit and scope of the invention as defined in the following claims.

What is claimed is:

1. A real estate sign system, comprising:
a plurality of real estate signs, each real estate sign comprising an electronic device and a stand, the electronic device further comprising a communications component in communications with a communications system and a visual display displaying a message to a viewer, the stand supporting the electronic device;
a plurality of user devices accepting information from a user and communicating that information to the real estate sign system; and
a control system comprising a web server and a communications component, the web server communicating with a user device to authenticate the user, receive an identification of a sign or a piece of real estate property, and a message to be displayed on the real estate sign, and in response to that information, communicating with the database to generate a message to be transferred to the real estate sign, the web server further communicating with the communications component to transfer information to the real estate sign.

2. The real estate sign system of claim 1, wherein the electronic device is contained within a housing mounted on the stand.

3. The housing of claim 2, wherein the housing is environmentally protected.

4. The real estate sign system of claim 1, wherein the electronic device comprises a communications component communicating with a microprocessor, the microprocessor further communicating with an internal memory and visual display.

5. The electronic device of claim 4, wherein the communications component receives information from the control system via the communications system and communicates that information to the microprocessor.

6. The electronic device of claim 4, wherein the microprocessor communicates with the communications component relaying information received from the control system, via the communications system, the microprocessor communicating with the internal memory to generate the message to be displayed, and further communicating with the visual display to display the desired message.

7. The electronic device of claim 4, wherein the internal memory communicates with the microprocessor and stores a plurality of messages to be displayed.

8. The electronic device of claim 4, wherein the visual display visually displays information relating to a piece of real estate property to a viewer.

9. The electronic device of claim 4, further comprising a power source which powers the electronic device.

10. The real estate sign system of claim 1, wherein the stand contains the elements of a conventional real estate sign.

11. A real estate sign system, comprising:
a plurality of real estate signs, each real estate sign comprising an electronic device and a stand, the electronic device further comprising a communications component in communications with a communications system, and a visual display displaying a message to a viewer, the stand supporting the electronic device;
a plurality of user devices accepting information from a user and communicating with a communications system to transfer information relating to a message to be displayed on a real estate sign.

12. The real estate sign system of claim 11, wherein the electronic device is contained within a housing being mounted on the stand.

13. The housing of claim 12, wherein the housing is environmentally protected.

14. The real estate sign system of claim 11, wherein the electronic device further comprises a communications component communicating with a microprocessor, the microprocessor further communicating with an internal memory and visual display.

15. The electronic device of claim 14, wherein the communications component receives information from the user device via the communications system and communicates that information to the microprocessor.

16. The electronic device of claim 14, wherein the microprocessor communicates with the communications component relaying information received from the user device, via the communications system, the microprocessor communicating with the internal memory to generate the message to be displayed, and further communicating with the visual display to display the selected message.

17. The electronic device of claim 14, wherein the internal memory communicates with the microprocessor and stores a plurality of messages to be displayed.

18. The electronic device of claim 14, wherein the visual display displays information relating to a piece of real estate property to a viewer.

19. The electronic device of claim 14, further comprising a power source which powers the electronic device.

20. The real estate sign system of claim 11, wherein the stand contains the elements of a conventional real estate sign.

21. A method for permitting a user to change the message on a remotely located real estate sign of a real estate sign system comprising the following steps:
accessing a user device to transmit a request for access to a control system;
receiving a screen from the control system and displaying the screen presenting the means to authenticate the user of the user device;
entering personal and security information of the user of the user device and transmitting that information to the control system;
receiving and displaying the screen presenting the user's information and data relating to the real estate sign system from the control system;
selecting one of a plurality of options for updating the real estate sign system such as updating an existing real estate sign or adding a new real estate sign;
when updating an existing real estate sign, entering the updated information such as a new message to be displayed on the display of the electronic device of the real estate sign or updating the information relating to the physical location of the real estate sign;
when adding a new real estate sign, entering the information relating to the new real estate sign such as a unique identification number, information relating to the physical location of the new real estate sign, and a message to be displayed on the display of the electronic device of the new real estate sign;
once the user has entered the updated information, transmitting that information to the control system;
receiving a screen presenting a confirmation of the updated information being processed and awaiting further inputs from the user such as when the user wishes to update additional real estate signs or add additional real estate signs;
selecting a second real estate sign to submit updated information to, selecting the option to add additional real estate signs, or selecting the option to terminate the session with the control system;
when submitting updated information to a second real estate sign or adding additional real estate signs, repeating the steps described above;
when terminating the session with the control system, selecting the option to terminate the current session and this information being transmitted to the control system;
receiving a screen presenting a confirmation that the current session has been terminated.

22. A method for permitting a web server to change the message on a remotely located real estate sign of a real estate sign system comprising the following steps:
receiving the request for access from a user device and transmitting a screen presenting a means to authenticate the user of the device;
receiving the personal and security information from the user device and communicating with a database to authenticate the user;
after authenticating the user, transmitting to the user device a screen to present that particular users information and data relating to the real estate sign system;
receiving from the user device one of a plurality of options for updating the real estate sign system such as updating an existing real estate sign or adding a new real estate sign;
when updating an existing real estate sign, receiving from the user device the updated information such as a new message to be displayed on the display of the electronic device of the real estate sign or updating the information relating to the physical location of the real estate sign;
when adding a new real estate sign, receiving from the user device information relating to the new real estate sign such as a unique identification number, information relating to the physical location of the new real estate sign, and a message to be displayed on the display of the electronic device of the new real estate sign;
receiving the updated information from the user device and communicating with the database to store the new information applicable to the user and further communicating with the communications component to transmit the message to be displayed on the real estate sign to the real estate sign;
transmitting to the user device a screen presenting a confirmation of the updated information being processed and awaiting further inputs from the user such as when the user wishes to update additional real estate signs or add new real estate signs;
when the user chooses to updated information on a second real estate sign or adding new real estate signs, repeating the steps described above;
when the user chooses to terminate the session, receiving the request to terminate the current session and communicating with the database to terminate the current session;
transmitting a screen to the user device presenting a confirmation that the current session has been terminated.
